(19) United States
(12) Patent Application Publication
(10) Pub. No.: US 2003/0154213 A1
(43) Pub. Date: Aug. 14, 2003

(54) Automatic community generation system and method on network

(76) Inventor: Jong-Sun Ahn, Seoul (KR)

Correspondence Address: FINNEGAN, HENDERSON, FARABOW, GARRETT & DUNNER, LLP, 1300 I STREET, NW, WASHINGTON, DC, 20005, US

(21) Appl. No.: 10/297,446

(22) PCT Filed: Jun. 8, 2001
(86) PCT No.: PCT/KR01/00980

(30) Foreign Application Priority Data
Jun. 9, 2000 (KR) 2000/31884
Nov. 3, 2000 (KR) 2000/65226

(51) Int. Cl. G06F 7/00

(52) U.S. Cl. 707/103 X

(57) ABSTRACT

The present invention relates to an automatic community generation system and method with hierarchical data structure. The automatic community generation system receives user's information through the network. At least one community is generated automatically according to the user's information. A major or area community can be located at top level of a hierarchical data structure referring to communities. A web page of a community includes link data, image data or university data and the data are constructed in predetermined position of the community web page. A user can select at least one community for working. The community generation system selects a private web data from the user's information. The private web data are appeared in the community web page to be entered by the user. The private web data or addresses of them are stored in database. At least one user's web page is generated from user's information and specified information of the community to be entered by the user. At least one user's web page is located within at least one web page of community.

### TECHNICAL FIELD

The present invention relates to an on-line community generation system and method, and in particularly relates to an automatic community generation system and method that creates major communities for like-minded users with Internet connections.

### BACKGROUND ART

Briefly, the Internet is a data communications network for performing data communication using Local Area Network (LAN) or Public Switched Telephone Network (PSTN) based upon Transmission Control Protocol/Internet Protocol (TCP/IP) between a plurality of unit networks identified by Internet Protocol (IP) addresses and with a plurality of hosts, each having private IP addresses within each unit network. The host, which means a computer with communication modem or phone line connection, may communicate with other hosts by transmitting messages between these unique IP addresses offered to each host.

A user tries to retrieve information from the Internet, the so called ‘sea of information’, get the desired information and make that to his own information.

Especially, the Internet facilitates electronic commerce, access to vast amounts of information in various formats, and diverse on-line communities that are currently growing and expanding. Also, by improving of technologies of various communication and service, Internet users further desire to form their own home pages or to form diverse spaces in a web site related to their interests. Hence, Internet service enterprises provide services like web hosting for corporations or individuals and allocate web hosting spaces to registered users for uploading their home pages.

A home page creation service is provided, which introduces a home page pre-manufactured by the service enterprise according to tastes of a user and of most benefit to beginners who cannot create own home page, but can create desired designs from the service site thereby selection. The representative two examples of such enterprises are www.netian.com and www.dreamwiz.com.

Because there is a vast amount of information available on the Internet by activating the Internet enterprises, users need a tool for filtering and locating desired high-quality information from among the numerous sources of unfiltered information. An example of such a tool is a category search engine provided by an Internet service enterprise. The category search engine has a Uniform Resource Locator (URL) link to make users search web sites in detailed depth or field of category by automatically generating URL categories with information. Two enterprises providing the above service are www.yahoo.com and www.altavista.com.

However, the prior category service provides the URL of a web site, but not detailed data content, character or quality of the enterprises.

Moreover, the prior web sites providing various communities, www.netian.com and www.daum.net, provide a service for exchanging information through bulletin board with a membership service having restricted circle type level.

### DISCLOSURE OF THE INVENTION

The present invention is intended to overcome the above-mentioned disadvantages. Therefore, it is an object of the present invention to provide automatic community generation system and method by forming major data fields like departments in order to complement the disadvantages of prior web sites with community services, to communize the same department and undergraduates or graduates with the same majors, and to make possible the communities of various data, chatting and search of information.

It is another object of the present invention to provide automatic community generation system by incorporating the function of a bookmark tool such as those loaded in the web browsers Internet Explorer or Netscape Navigator into the system. This would enable each user to move desired web sites rapidly because the book-marked web sites URL's would be stored within their system's memory.

It is another object of the present invention to make possible the simple generation of personal home pages together with a capability to edit those pages. This is achieved by generating basic home pages composed of the user's registration data and automatic modification of those pages in agreement with the tastes of the user.

To achieve the above objective of generating mutually distinguishable on-line communities, by constructing a data structure with hierarchical levels, an automatic community generation method of the present invention may comprises a step of locating a major department or area at top level, a step of constructing hierarchical data structure based upon major department by locating category information for major department, area or school at the lower level according to the contents located at the top level, a step of generating a web page for the major community for at least one users to utilize by composing a specified form from at least one selected from a group consisting of link information related to a major department, a major related image and major related news, and a step of assigning the user membership status in at least one of the communities according to the user's major field submitted by the user via a network.

The user information may further comprises at least one selected from a group consisting of a resident registration number, address, scholarship, taste, occupation, major department, marital status, color and study abroad.

The category information may comprise at least one selected from a group consisting of college, academic number, date of generating the on-line community and related site information.

The web page of the major community may be constructed to link automatically to a site related to the user's major field.

The step of generating a web page for the major community may further comprise a step of revising the contents of the web page in accordance with the user's request.

The automatic community generation method may further comprise a step of generating at least one user's private home page consisting of background color, inserted image, user's instruction or linked site information with pre specified forms containing contents information related to a user's information and user's subscribed on-line community.

The step of generating at least one user's private home page may further comprise a step of generating text or images with pre-specified forms for linking to sites related to that user's major field.

The step of generating at least one user's private home page may further comprise a step of generating polyhedron images capable of being scrolled by users and a step of displaying the on-line communities subscribed by the user in each surface of the polyhedron and displaying that in corresponding user's screen.

The automatic community generation method may further comprise a step of providing a bookmark tool for connecting to corresponding sites immediately at the request of the user by storing the selected site location information among a plurality of URL's sites visited by the user.

The step of providing a bookmark tool may further comprise a step of establishing a default starting-page for moving directly to a web page of corresponding site by recognizing previously a default starting-page selected by the user among sites stored in the bookmark tool in the process of connecting to network.

The automatic community generation method may further comprise a step of generating a new on-line community at a specified level at user's request.

Moreover, for generating mutually distinguishable on-line communities by constructing data structure with hierarchical level, an automatic community generation method of the present invention may comprises a step of locating a major department at top level, a step of constructing hierarchical data structure based upon major department by locating area or university information for the major department at the lower level according to the contents located at the top level and a step of generating a web page for a major community for at least one users to utilize by composing specified form from at least one selected from a group consisting of link information related to user's major department, major related image and major related news.

Moreover, for generating mutually distinguishable communities by constructing data structure with hierarchical levels, an automatic community generation method of the present invention may comprises a step of locating area at top level, a step of constructing hierarchical data structure based upon the area by locating major department at the lower level of the top level and locating category information for university at the lower level of the major department, a step of generating a web page for the major community for at least one users to utilize by composing specified form from at least one selected from a group consisting of link information related to user's major department, major related image and major related news, and a step of assigning the user as a member of at least one communities according to the user's major field submitted among the user information received from the user via a network.

The automatic community generation method may further comprise a step of generating at least one user's private home page consisting of background color, inserted image, user's instruction or linked site information with pre specified forms using contents information related to the user's information and user's subscribed community.

Moreover, for generating mutually distinguishable communities by constructing data structure with hierarchical level, an automatic community generation method of the present invention may comprises a step of constructing a hierarchical data structure with a plurality of levels of fields for including category information about major departments, areas and schools, a step of generating a web page for a major community for at least one users to utilize by composing specified forms from at least one selected from a group consisting of link information related to user's major department, major related image and major related news, and a step of assigning the user as a member of at least one communities according to the user's major field submitted among the user information received from the user via network.

The category information may comprise information for major department located at top level and for corresponding area or university located at the lower level.

The category information may comprise information for area located at top level, information for major department located at lower level of the top level and information for university located at lower level of the major department.

Moreover, an automatic private home page generation method of the present invention may comprise a step of constructing a hierarchical data structure with a plurality of levels for including category information about major departments, areas and schools, a step of receiving user's information from the user via network, and a step of generating at least one user's private home pages using the received user's information, wherein the at least one user's private home pages may comprise private region with private history information among user's information, and major related region including at least one selected from a group consisting of link information of web sites, image and news that are related to user's major field.

The private history information may comprise at least one selected from a group consisting of a photo, name, date of user's birth, address and private introduction.

Moreover, a method of automatic controlling bulletin boards of the present invention may comprise a step of constructing a hierarchical data structure with a plurality of levels for including category information related, to major departments, areas and schools, a step of generating bulletin boards belonging to web pages of communities of major departments, areas or schools to display writings recorded by members of community according to user's selection, a step of assigning the users to corresponding communities according to user's information provided by users via a network, and a step of registering a writing being recorded by a user to all bulletin boards of the communities that the user has been subscribed or to those bulletin boards selected by the user for external reading when the user records a writings to a specific bulletin board.

Moreover, an automatic user's home page generation method of the present invention may comprise a steps of receiving user's information from the user via a network, a step of receiving at least one selection information for a community from the user, a step of storing contents for displaying on the home page of the community or location existed the contents among the user's information in a database, and a step of generating corresponding at least one user's home page in at least one communities using information for the user or communities.

Moreover, a method of displaying bulletin boards of the present invention may comprise a step of determining a user's community based upon that user's career on network, a step of displaying communities composed of a plurality of groups in the form of a matrix, a step of optionally selecting writings corresponding to the plurality of communities and a step of displaying the selected writings on the bulletin boards of corresponding communities.

Moreover, a method of displaying bulletin boards of the present invention may comprise a step of receiving user's information and at least one communities including the users from users via network, a step of receiving writings recorded by the users, and a step of storing the writings in database for connection to at least one other written submissions belonging to at least one community related to users, wherein, the written submissions are displayed on the bulletin boards of related communities by selection.

Moreover, a method of performing a bookmark tool of the present invention may comprise a step of receiving users' information and at least one communities including the those users via a network, a step of storing home page information for the communities selected by the users, at least one frame information representing the home page and related information for each subsequent frame stored in a database, a step of providing the home page information to the users at the user's request, and a step of converting the screen to corresponding home page among the list of submitted home pages information displayed in a side panel of the screen for user's selection.

The step of providing the home page information to the users may display newly added home page information in a different format with the prior home page information during a specified period.

The different form may be at least one selected from a group consisting of color, shape, size, gradient, underline and thickness.

Moreover, an automatic community generation system of the present invention may comprise a memory system including a database for the user's information and communities, at least one processor connected to said memory system, an input device for entering signals provided through a network to said processors, and an output device for generating output signals from said processors, wherein, the database may comprise an area entity including area code and information related to corresponding area, a university entity, which includes the area code, university code and information related to corresponding universities, connecting to said area entity by the area code, a home page entity, which includes the area code, university code, department (college) code and information related to the home page of the department (college), connecting to said university entity by the area code and university code, a department (college) entity, which includes the department (college) code and information related to the department (college), connecting to said home page entity by the department (college) code, and a professor entity, which includes the area code, university code, department (college) code and information related to the professor, connecting to said university entity by the area code and university and connecting to said department (college) entity by the department (college) code.

Moreover, an automatic community generation system of the present invention may comprise a memory system having a database including category information composed of information for a major department located at a top level and for a corresponding area or university located at the lower level and user's information, a transmitter for transmitting the category information based upon the major department at the user's request, and a community generator for generating the major community for the field requested by the user from among the category information.

The database may comprise an area entity including area code and information related to corresponding area, a university entity, which includes the area code, university code and information related to corresponding universities, connecting to said area entity by the area code, a home page entity, which includes the area code, university code, department (college) code and information related to the home page of the department (college), connecting to said university entity by the area code and university code, a department (college) entity, which includes the department (college) code and information related to the department (college), connecting to said home page entity by the department (college) code, a professor entity, which includes the area code, university code, department (college) code and information related to the professor, connecting to said university entity by the area code and university and connecting to said department (college) entity by the department (college) code.

The user information may further comprises at least one selected from a group consisting of a resident registration number, address, scholarship, taste, occupation, major department, marital status, color and study abroad.

The category information may comprise at least one selected from a group consisting of college, academic number, date of generating the community and related site information.

The automatic community generation system may further comprise a home page generator for generating private home pages with pre specified form using user's private profiles from among the user's submitted information.

The automatic community generation system may further comprise a provider a bookmark tool for connecting immediately to registered home page at user's request registering the address information of the home page selected from the user among home pages visited by the user.

The bookmark tool may comprise a default starting-page establisher for displaying a default starting-page selected for the user from among sites previously stored in the list of bookmark when the user connected to them.

Moreover, an automatic community generation system of the present invention may comprise a memory system having hierarchical data including category information that composed of area information located at top level and major department or university information located at the lower level and user's information, a transmitter for transmitting the category information based upon the major department at the user's request, and a community generator for generating the major community related to the field requested by the user from among the category information.

The hierarchical data may comprise an area entity including area code and information related to corresponding area, a university entity, which includes the area code, university code and information related to corresponding universities, connecting to said area entity by the area code, a home page entity, which includes the area code, university code, department (college) code and information related to the home page of the department (college), connecting to said university entity by the area code and university code, a department (college) entity, which includes the department (college) code and information related to the department (college), connecting to said home page entity by the department (college) code, and a professor entity, which includes the area code, university code, department (college) code and information related to the professor, connecting to said university entity by the area code and university and connecting to said department (college) entity by the department (college) code.

Moreover, an automatic community generation system of the present invention may comprise a memory system having hierarchical data with a plurality of levels including category information for major department, area and university, a transmitter for transmitting the category information based upon the major department by the user's request, and a community generator for generating the major community of the field requested by the user among the category information.

The category information may comprise major department information at top level and corresponding area or university location located at the lower level.

The category information may comprise information for area located at top level, information for major department located at lower level of the top level and information for university located at lower level of the major department.

Moreover, a computer-readable medium for generating community automatically of the present invention may be used to store thereon computer-executable instructions and realized in concrete by program of instructions, which could be executable by digital processing unit, for automatically generating communities held in common by a plurality of user via a network, said method of automatically generating community may comprise a step of locating a major department or area information at a top level, a step of constructing a hierarchical data structure based upon major department by locating category information for major department, area or school at the lower level according to the contents located at the top level, a step of generating a web page for the major community for at least one user to utilize by composing specified forms consisting of at least one selected from a group consisting of link information related to major department, major related image and major related news, a step of receiving user information from at least one user connected, via the network, wherein, the user information includes at least one selected from a group consisting of major department and area, and a step of assigning the user as a member of at least one community according to the user's major field from among the user information received from the users via the network.

### BRIEF DESCRIPTION OF THE DRAWINGS

FIG. 1 is a schematic illustration of an automatic community generation system in accordance with one preferred embodiment of the present invention.

FIG. 2 is a schematic illustration of a computer system used in an automatic community generation system in accordance with one preferred embodiment of the present invention.

FIG. 3 is a flow chart illustrating an automatic community generation method in accordance with one preferred embodiment of the present invention.

FIG. 4 illustrates a table of categories including various communities in the automatic community generation system in accordance with one preferred embodiment of the present invention.

FIG. 5 illustrates a table of categories in the automatic community generation system in accordance with one preferred embodiment of the present invention.

FIG. 6 illustrates a data chart as tree structure in the automatic community generation system in accordance with one preferred embodiment of the present invention.

FIG. 7 illustrates a database structure by applying the table of categories in FIG. 5 to the database in FIG. 6 as it is.

FIG. 8 illustrates a database structure based on area node in the automatic community generation system in accordance with one preferred embodiment of the present invention.

FIG. 9 illustrates a database structure using Entity Relationship Diagram (ERD) in the automatic community generation system in accordance with one preferred embodiment of the present invention.

FIG. 10 illustrates a data field of the area entity depicted in FIG. 9.

FIG. 11 illustrates a data field of the university entity depicted in FIG. 9.

FIG. 12 illustrates a data field of the home page entity depicted in FIG. 9.

FIG. 13 illustrates a data field of the college entity depicted in FIG. 9.

FIG. 14 illustrates a data field of the professor entity depicted in FIG. 9.

FIG. 15 illustrates a screen for managing communities in the automatic community generation system in accordance with one preferred embodiment of the present invention.

FIGS. 16 through 21 illustrate a screen showing communities generated by selection of a user in the automatic community generation system in accordance with one preferred embodiment of the present invention.

FIG. 22 is a flow chart illustrating process, which a home page is generated automatically according to a user's request in the automatic community generation system in accordance with one preferred embodiment of the present invention.

FIG. 23 illustrates a screen used for entering user's information in process of registering as a member in the automatic community generation system in accordance with one preferred embodiment of the present invention.

FIG. 24 illustrates a screen used for requesting additional data to a user when generating a home page.

FIG. 25 is a schematic diagram illustrating the relationship between a user's private home page and a user-subscribed community home page in the automatic community generation system in accordance with one preferred embodiment of the present invention.

FIG. 26 is a flow chart illustrating process of using a bookmark tool by a user in the automatic community generation system in accordance with one preferred embodiment of the present invention.

FIG. 27 illustrates a screen that uses a cubic polyhedron to display communities in the automatic community generation system in accordance with one preferred embodiment of the present invention.

### <Designation of Important Components Represented in the Attached Drawings>

| | | | |
|---|---|---|---|
| 10: | undergraduate | 20: | public |
| 30: | expert | 100: | network |
| 110: | web server | 120: | database |
| 112: | bookmark generator | 114: | community generator |
| 116: | home page generator | 121: | user information database |
| 122: | home page information | 123: | category information database |
| | database | | |
| 124: | contents information | 125: | bookmark information |
| | database | | database |
| 126: | index information database | | |
| 220: | computer system | 224: | CPU |
| 226: | memory system | 228: | input device |
| 230: | output device | 234: | ALU |
| 236: | registers | 238: | control unit |
| 240: | main memory | 242: | secondary memory |

### BEST MODES FOR CARRYING OUT THE INVENTION

Hereinafter, preferred embodiments of the present invention will be described in more detail with reference to the accompanying drawings.

An automatic community generation system of the present invention is intended to show new Internet communities and act as a guidepost to future-oriented communities.

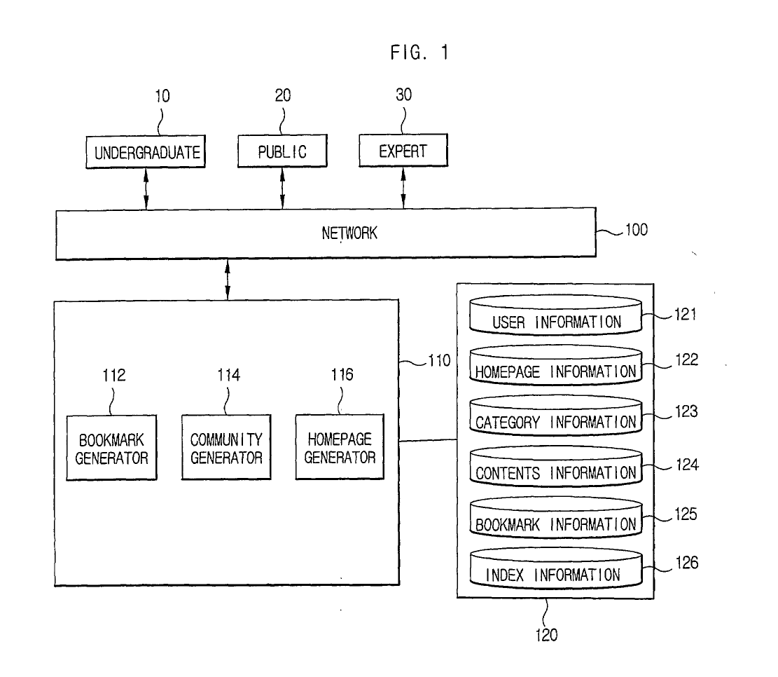

FIG. 1 is a schematic illustration of an automatic community generation system in accordance with one preferred embodiment of the present invention. Referring to FIG. 1, the automatic community generation system may include a web server 110 used for generating communities in accordance with requests from an undergraduate 10, a public 20, an expert 30 or other users via a network 100. The web server 100 may include a community generator 114 that automatically generating a community using information such as undergraduate's major department, a special field of the public 20 or a field related to a type of business performed by an expert 30 such as a professor or researcher. In addition to the community generator 114, the web server 100 may further include a home page generator 116 used for generating and modifying a home page by user's request, and a bookmark generator 112 used for storing addresses and the contents of web sites visited by a user.

The web server 110 may utilize user information, community information or other information stored in a database 120 in order to generate a community according to a user's request. The database 120 may include a category information database 123 with category information classified into a user's department or major, content information database 124 with contents information about detailed contents according to the categories, and an index information database 126 with index information that helps other users to search each community.

Moreover, the home page generator 112 in the web server 110 may generate a pre-designed home page using detailed information from the user information stored in the database 120 in accordance with a user's request. When a user wants to generate a home page, the web server requires detailed user information from the user and requests this in order to help the user construct a basic home page. Once the user's home page is constructed, home page information, category information, contents information and index information pertaining to the user's home page are stored in corresponding databases 122, 123, 124, 126.

Also, bookmark information including addresses and related contents of various web sites visited by the user will be stored in the bookmark information database 125 by the bookmark generator 112 in the web server 110. The user can choose basic web site displayed in a screen when the user connected to the web server 110 by the bookmark generator 112. Having stored the address of the basic web site selected by the user, the bookmark generator 112 recognizes connected user's ID and displays the selected basic web site on the screen.

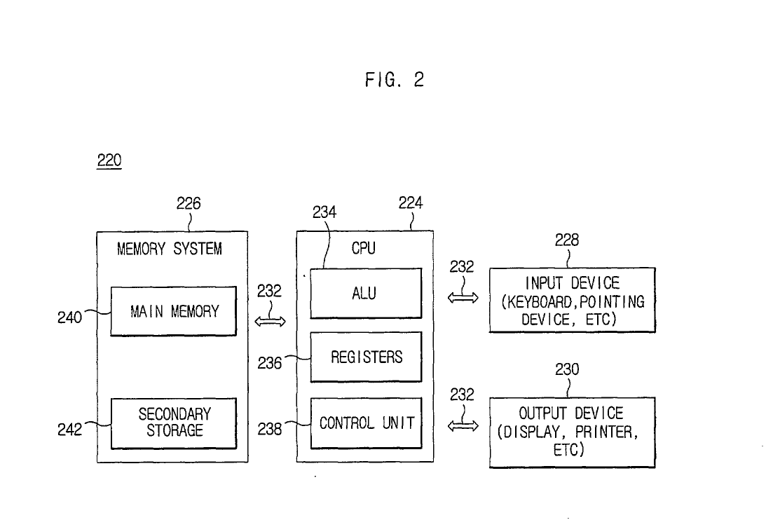

FIG. 2 is a schematic illustration of a computer system used in an automatic community generation system in accordance with one preferred embodiment of the present invention. Referring to FIG. 2, a computer system 220 includes a memory system 226, at least one high speed Central Processing Unit (CPU) 224 in conjunction with that, an input device 228 and an output device 230.

The CPU 224 includes an Arithmetic Logic Unit (ALU) 234 for performing computations, a collection of registers 236 for temporary storage of data and instructions, and a control unit 238 for controlling operation of the computer system 220. The CPU 224 may be a processor having any of a variety of architectures including Alpha from Digital, MIPS from MIPS Technology, NEC, IDT, Siemens, and others, x86 from Intel and others, including Cyrix, AMD, and Nexgen, and PowerPC from IBM and Motorola.

The memory system 226 generally includes high-speed main memory 240 in the form of a medium such as Random Access Memory (RAM) and Read Only Memory (ROM) semiconductor devices, secondary storage 242 in the form of long term storage mediums such as floppy disks, hard disks, tape, CD-ROM, flash memory, etc. and other devices that store data using electrical, magnetic, optical or other recording media. The main memory 240 also can include video display memory for displaying images through a display device. Those skilled in the art will recognize that the memory system 226 can comprise a variety of alternative components having a variety of storage capacities.

The input and output devices 228, 230 also are familiar. The input device 228 can comprise a keyboard, a mouse, and a physical transducer (e.g., a touch screen or microphone), etc. The output device 230 can comprise a display, a printer, and a transducer (e.g., a speaker), etc. Some devices, such as a network interface or a modem, can be used as input and/or output devices.

As is familiar to those skilled in the art, the computer system 220 further includes an operating system and at least one application program. The operating system is the set of software that controls the computer system's operation and the allocation of resources. The application program is the set of software that performs a task desired by the user, using computer resources made available through the operating system. Both are resident in the illustrated memory system 226.

In accordance with the practices of persons skilled in the art of computer programming, the present invention is described below with reference to acts and symbolic representations of operations that are performed by computer system 220, unless indicated otherwise. Such acts and operations are sometimes referred to as being computer-executed and may be associated with the operating system or the application system as appropriate. It will be appreciated that the acts and symbolically represented operations include the manipulation by the CPU 224 of electrical signals representing data bits which causes a resulting transformation or reduction of the electrical signal representation, and the maintenance of data bits at memory locations in memory system 226 to thereby reconfigure or otherwise alter the computer system's operation, as well as other processing of signals. The memory locations where data bits are maintained are physical locations that have particular electrical, magnetic, or optical properties corresponding to the data bits.

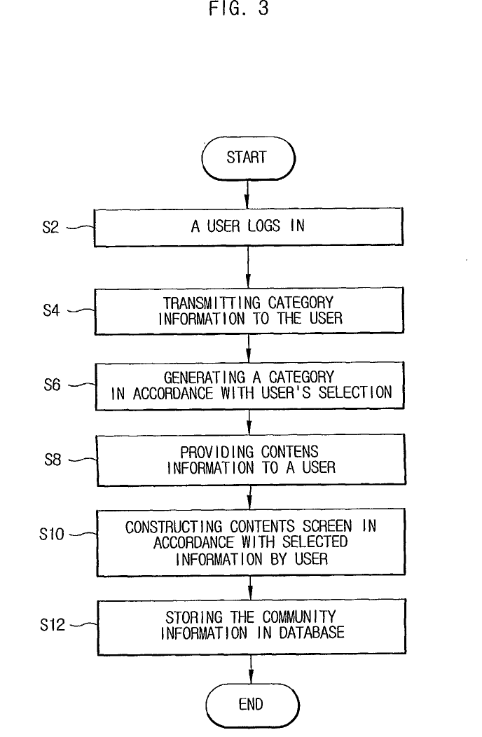

FIG. 3 is a flow chart illustrating automatic community generation method in accordance with one preferred embodiment of the present invention. Referring to FIG. 3, a user connected to a web server via a network logs in using an ID and a password (s2). The web server transmits category information stored in a database to the user when the user requests generation of a community (s4). When the user selects a community to generate from among the category information, a community generation system generates a category including the selected community (s6). For example, if a user intends to generate a community because the user is a vocal music major at the College of Music in Seoul National University, the user can first select College of Music and select vocal music in the subordinate menu. Then, the user can select Seoul National University from regional universities including the College of Music. Thus, communities are generated for Vocal music/College of music/Seoul National University. Undergraduates in vocal music, professors, graduates or students who wish to enter can subscribe to the community as members. On the other hand, when a community that users wish to enter is already generated, users are subscribed to the community automatically or can selectively subscribe to a community.

As a community being generated, a user can select contents information for the community. For this purpose, the web server provides various content information (s8). A community generation system constructs a community home page using the selected information when the user selects desired information from the provided information (s10). Then, information for the constructed home page by the user and content information will be stored in database (s12).

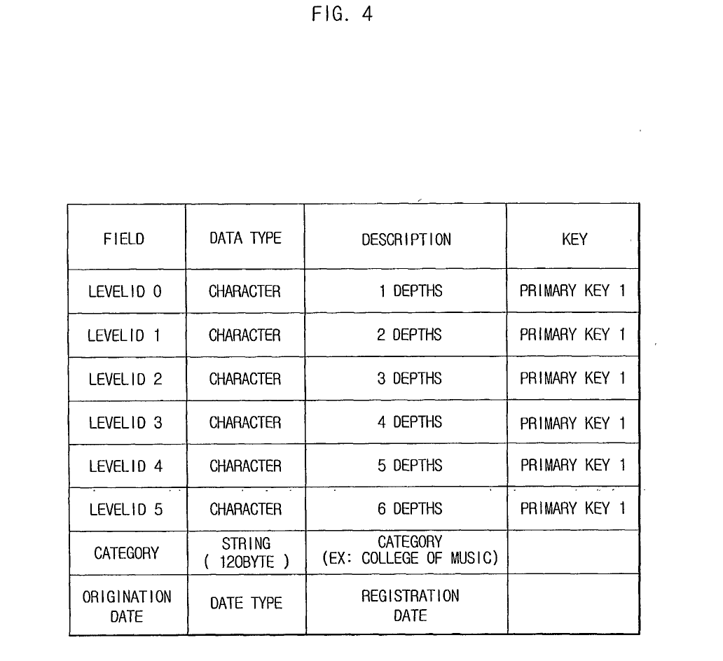

FIG. 4 illustrates a table of category information including various communities in the automatic community generation system in accordance with one preferred embodiment of the present invention. Referring to FIG. 4, the table of category information is composed of sequential categories from the top level (LEVEL ID 0) to the lower levels (LEVEL ID 1, . . . , LEVEL ID 5). Each category (LEVEL ID 0, . . . , LEVEL ID 5) includes a field for each level and information for giving each user's registration date. Each level can have a different data format of character. Also, the category table includes the name of each category and its origination date. The names of the categories are depicted as being composed of string of 120 bytes and the origination date is represented in date type format.

Although described above as an example the category is composed of a table with 6 levels, it is appreciated that the number of levels of categories is controllable by reduction or incremental increase in the amount of detailed community information.

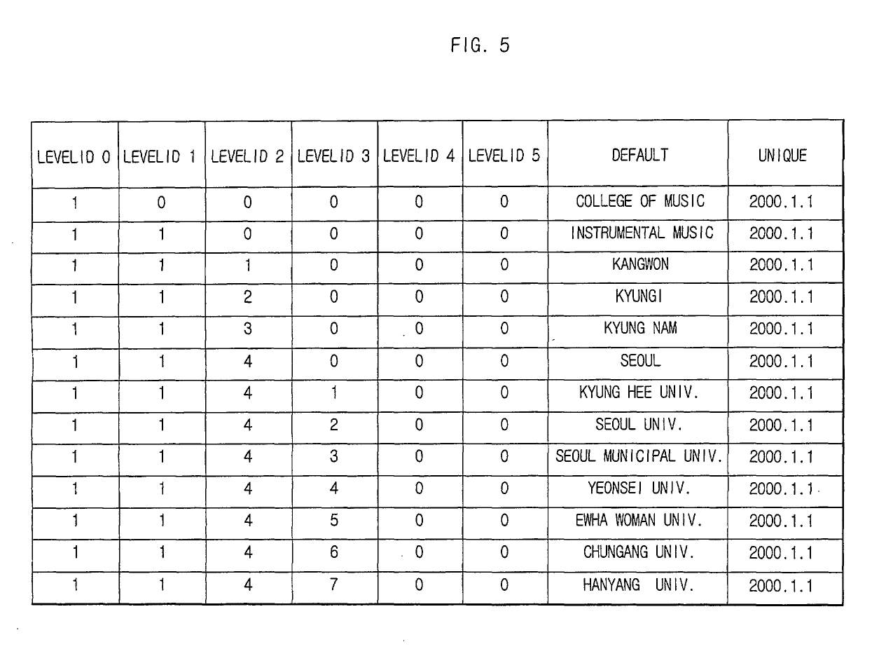

FIG. 5 illustrates a table of categories in the automatic community generation system in accordance with one preferred embodiment of the present invention. Referring to FIG. 5, the table of categories is composed of the college (Music) category as top level, department (Instrumental Music) category as second level and area (Kyungi, Kyungnam, Seoul) category with name of school administrating the departments as third level. Also, the fourth level is composed of school (Kyunghee University, Seoul University, Seoul Municipal University, Yeonsei University, Ewha Woman University, Chungang University, Hanyang University) category. Thus, because the top level corresponds to colleges and the subordinate levels include department, area and school sequentially, the user can generate desired communities in the order of and including college, department, area and school.

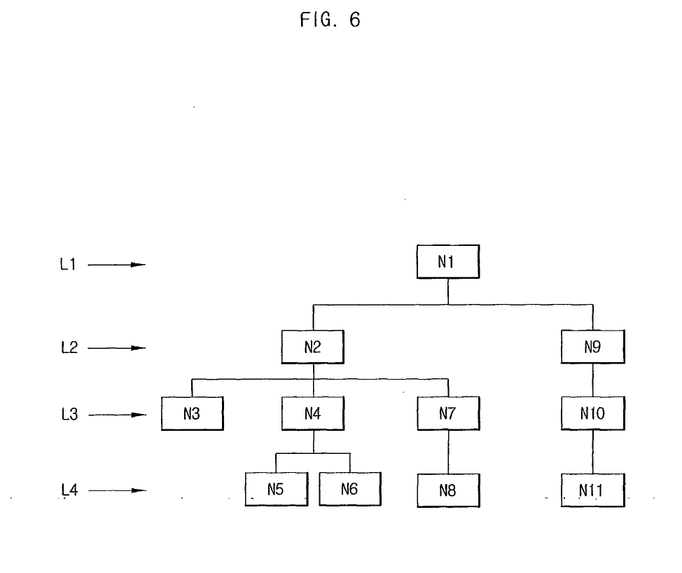

FIG. 6 illustrates a data chart with a tree structure in the automatic community generation system in accordance with one preferred embodiment of the present invention. Referring to FIG. 6, the database includes multiple nodes N1, . . . , N11 that are at different hierarchical levels L1, . . . , L4 and includes connecting branches that represent hierarchical links. The particular hierarchical relationships depicted in FIG. 6 are illustrative and the database chart could include virtually any relationships between nodes N1, . . . , N11 and levels L1, . . . , L4 according to the invention. Nodes N1, . . . , N11 that are at different hierarchical levels than L1, . . . , L4 are sometimes referred to as having parent or child relationships. A parent node (e.g., N2 node) is at a hierarchically higher level L2 than the level L3 of a child node (e.g., N3 node).

Nodes N1, . . . , N11 are labeled with a generic numeric nomenclature, but applied to represent actual information. Examples of the types of information include: the hierarchical levels of an organization such as a corporation, government, etc., relationships between the areas (e.g., nations, cities, etc.) and components within an article, relationships between machine and components in a software program, and the relationships between information sources such as computer files, and sites on local or global computer networks.

In one implementation, the information within the chart in FIG. 6 comes from a data source or record within a database having multiple fields. Each field corresponds to a category of information in the database. The database includes multiple data records that each includes data in one or more of the fields. The database data source may be any of variety of databases and database formats including Open Database Connectivity (ODBC) databases such as Access and SQL server from Microsoft Corporation and Oracle from Oracle Corporation.

Appling the structure of the database to universities, node N1 placed at first level L1 corresponds to colleges and nodes N2, N9 placed at the second level L2 correspond to major departments. A user utilizing the automatic community generation system of the present invention may belong to a major department in a college. Nodes N3, N4, N7, N10 placed at the third level L3 correspond to area and nodes N5, N6, N8, N11 placed as fourth level nodes correspond to school. A user selects a college and department, and then selects a university corresponding to their own geographical area. The colleges and departments may be different at every university. Because specific colleges or departments can be operating in restricted areas, the structure of the database may be changed in accordance with changes in department, area or university.

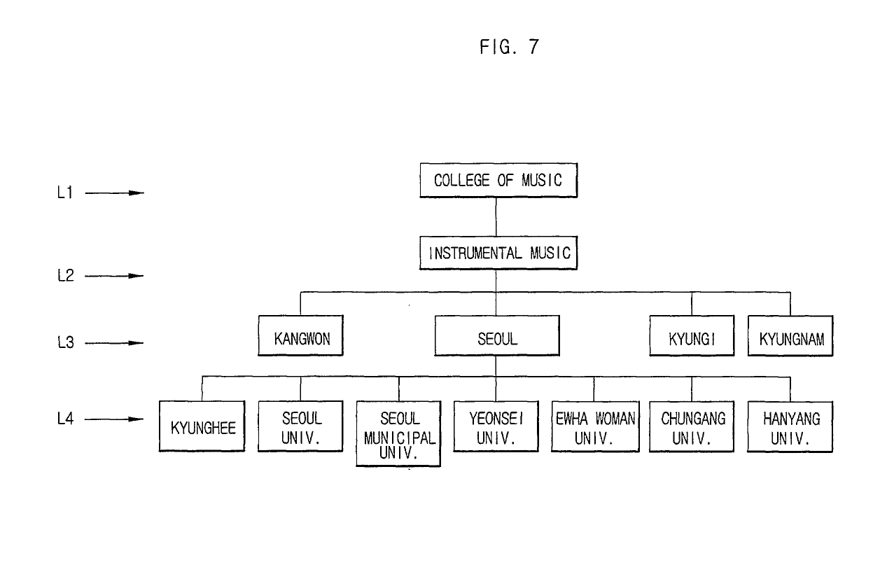

FIG. 7 illustrates a structure of a database by applying the table of categories in FIG. 5 to the database in FIG. 6 as it is. Referring to FIG. 7, a College of Music as college is located in a node corresponding to the first level L1 and Instrumental Music is located in the child node, which corresponds to the second level L2, of the College of Music in automatic community generation system. Area nodes for Kangwon, Seoul, Kyunggi, and Kyungnam corresponding to an area where the departments of Instrumental Music are open, are placed at the subordinate level L3 and university nodes (Kyunghee Univ., Seoul Univ., Seoul Municipal Univ., Yeonsei Univ., Ewha Woman Univ., Chnunang Univ., Hanyang Univ.) in which the department of Instrumental Music is open among universities in the Seoul area, are placed at the subordinate level L4, the node for the Seoul area. Therefore, a user can easily construct a community including users with the same major as components. Although colleges are placed at the top level above, departments instead of the colleges may be placed at the top level. In the structure of the database depicted in FIG. 6 and FIG. 7, a node of college is placed at the top level L1 and subordinate levels include the nodes of departments, areas and universities in hierarchical level sequentially. However, a user can construct a community based on a node area instead of a college or department.

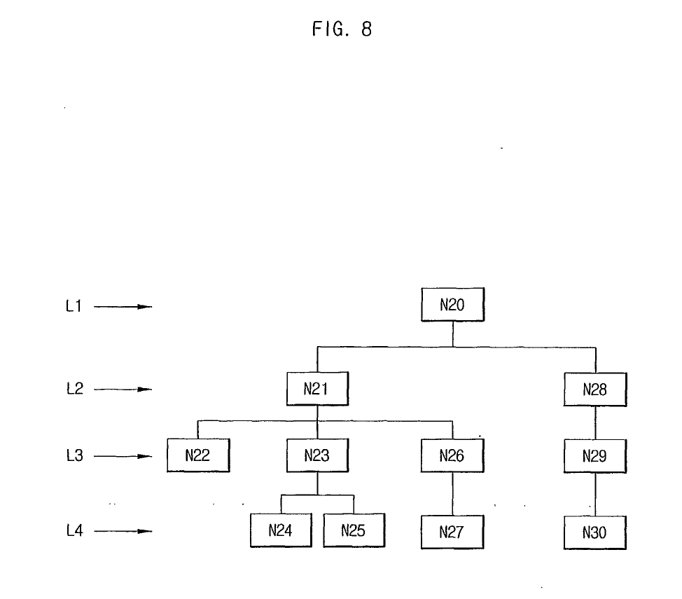

FIG. 8 illustrates a structure of a database based on a node of area in the automatic community generation system in accordance with one preferred embodiment of the present invention. Referring to FIG. 8, node N20 is placed at the first level L1 corresponding to the top level and nodes N21, N28 for colleges being opened in the node N20 of area, are placed at the second level L2. Nodes N22, N23, N26, N29 for departments belonging to the colleges, are placed at the third level L3, which is the child node of the nodes N21, N28 for college. The subordinate level L4 is composed of nodes N24, N25, N27, N30 for university including the corresponding departments. If the node of area placed at the third level L3 was placed at the top level L1 and the nodes of college and university were placed one lever lower in the structure of the database in FIG. 6, a structure equivalent to that of the database in FIG. 8 is constructed.

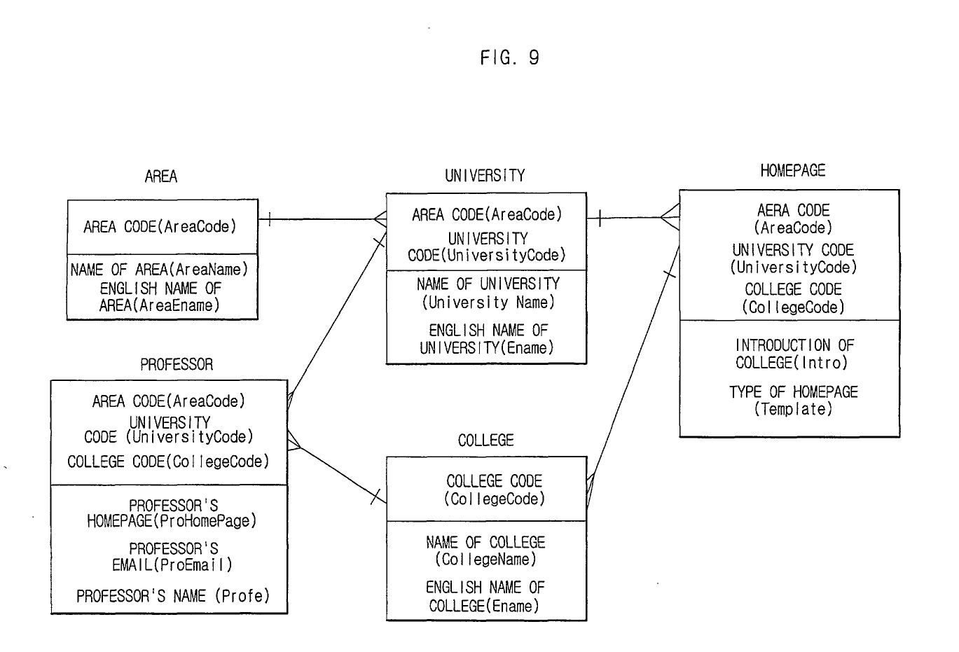

FIG. 9 illustrates a structure of a database using Entity Relationship Diagram (ERD) in the automatic community generation system in accordance with one preferred embodiment of the present invention. The relationship between each entity is described below referring to FIG. 9.

An area entity (Area) includes a plurality of university entities (University) and the university entity (University) includes a plurality of home page entities (Home page) and a plurality of professor entities (Professor). A college entity (College) includes a plurality of professor entities (Professor) and a plurality of home page entities (Home page).

The university entity (University) includes attributes of an area code (AreaCode), university code (UniversityCode), name of university (UniversityName) and English name of university (Ename). The university entity (University) is connected to the area entity (Area) using the area code (AreaCode) as a Foreign Key (FK) and is connected to the home page entity (Home page) using the university code (UniversityCode) as a foreign key. The area code (AreaCode) and university code (UniversityCode) are used as primary key.

The area entity (Area) includes attributes of an area code (AreaCode), name of area (AreaName) and English name of area (AreaEname) and is connected to the university entity (University) using the area code (AreaCode). The area code (AreaCode) is used as primary key.

The home page entity (Home page) includes attributes of an area code (AreaCode), university code (UniversityCode), college code (CollegeCode), introduction to college (Intro) and type of home page (Template). The home page entity Some page) is connected to the university entity (University) using the area code (AreaCode) and university code (UniversityCode) as a foreign key (FK) and is connected to the college entity (College) using the college code (CollegeCode) as a foreign key (FK). The home page entity (Home page) uses the area code (AreaCode), college code (CollegeCode) and university code (UniversityCode) as primary keys (PK).

The college entity (College) includes attributes of a college code (CollegeCode), name of college (CollegeName) and English name of college (CollegeEname). And, the college entity (College) is connected to the home page entity (Home page) and the professor entity (Professor) using the college code (CollegeCode) as a foreign key (FK). The college code (CollegeCode) is used as a primary key (PK).

The professor entity (Professor) includes attributes of an area code (AreaCode), university code (UniversityCode), college code (CollegeCode), professor's home page (ProHome page), professor's e-mail (ProEmail) and professor's name (Profe). The professor entity (Professor) is connected to the university entity (University) using the area code (AreaCode) and university code (UniversityCode) as foreign keys (FK) and is connected to the college entity (College) using the college code (CollegeCode) as a foreign key (FK). Also, the area code (AreaCode), university code (UniversityCode) and college code (CollegeCode) are used as primary keys (PK).

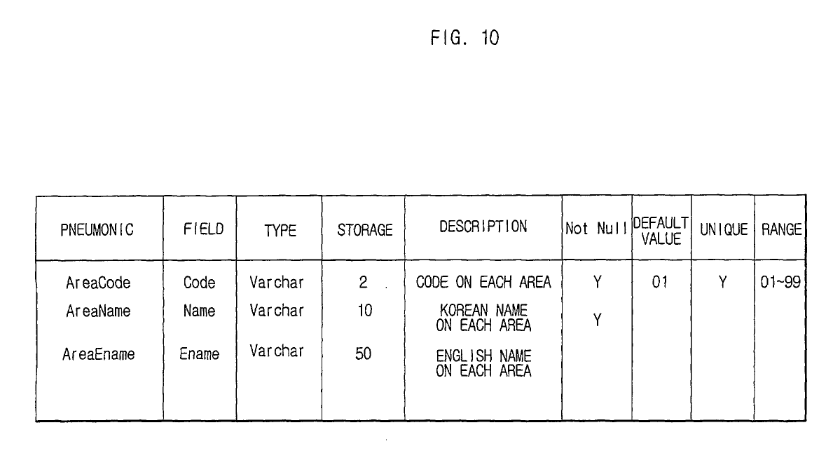

FIG. 10 illustrates a data field of the area entity depicted in FIG. 9. Referring to FIG. 10, variables of the area entity (Area) are an area code (AreaCode), name of area (AreaName) and English name of area (AreaEname), and are the type of variable character (Varchar) everybody. The area code (AreaCode) indicates a code for each area and it has a storage size of 2 and does not display a NULL value. Also, the default value of the area code (AreaCode) is 01 with range of 01-99. The area name (AreaName) is a Korean name for each area and does not display a NULL value. The area name has a storage size of is 10. The English name (AreaEname) indicates an English name for each area and has a storage size of 50.

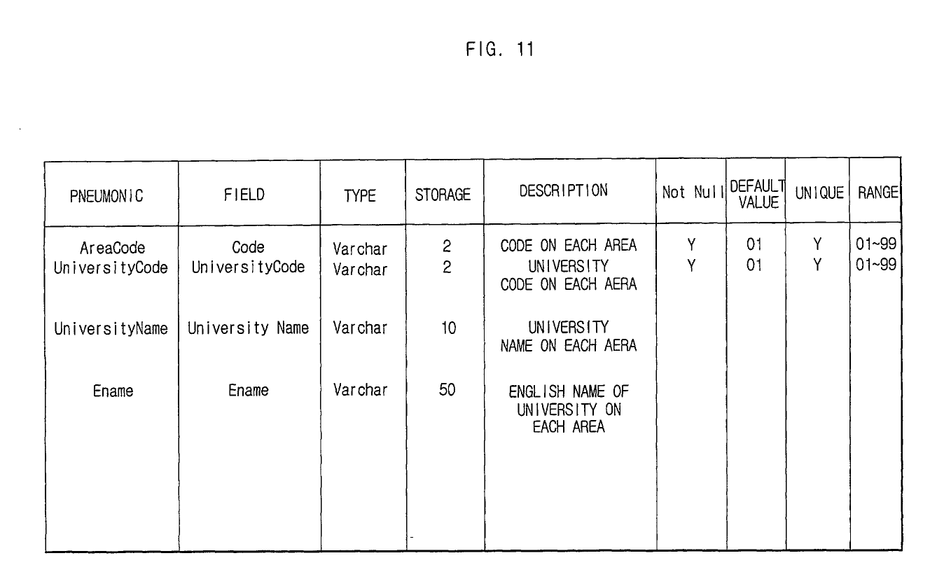

FIG. 11 illustrates a data field in the university entity depicted in FIG. 9. Referring to FIG. 11, the university entity (University) includes variables of an area code (AreaCode), university code (UniversityCode), name of university (UniversityName) and English name of university (Ename) consisting of characters of various format types. The area code (AreaCode) and university code (UniversityCode) have storage size of 2 and default values of 01 respectively. Also, these codes do not display NULL values and have a range of 01-99.

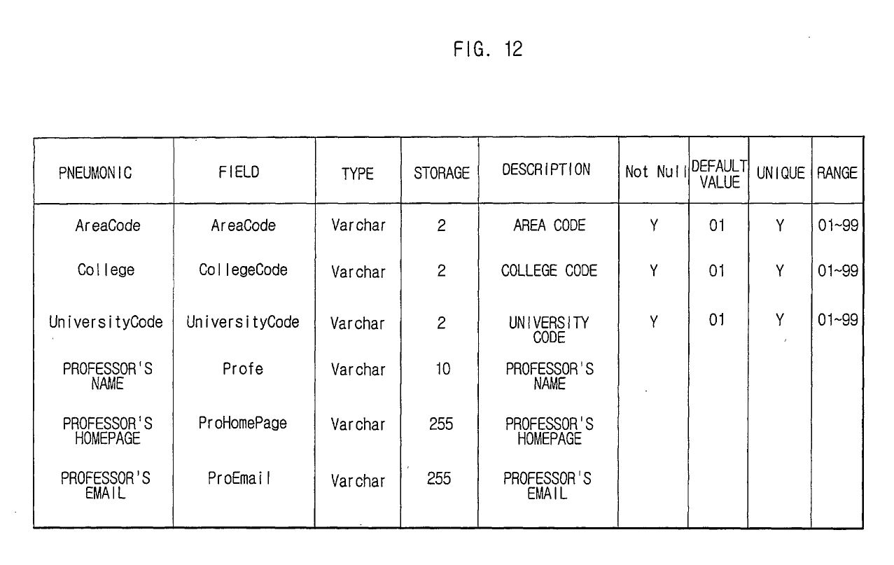

FIG. 12 illustrates a data field of the home page entity depicted in FIG. 9. Referring to FIG. 12, the home page entity (Home page) includes variables of an area code (AreaCode), college code (CollegeCode), university code (UniversityCode), introduction to the college (Intro) and type of home page (Template). Every variable follows a certain data format and does not have a NULL value. The introduction to the college (Intro) includes contents for introducing the colleges to students and it is preferred to provide storage size of 2,048.

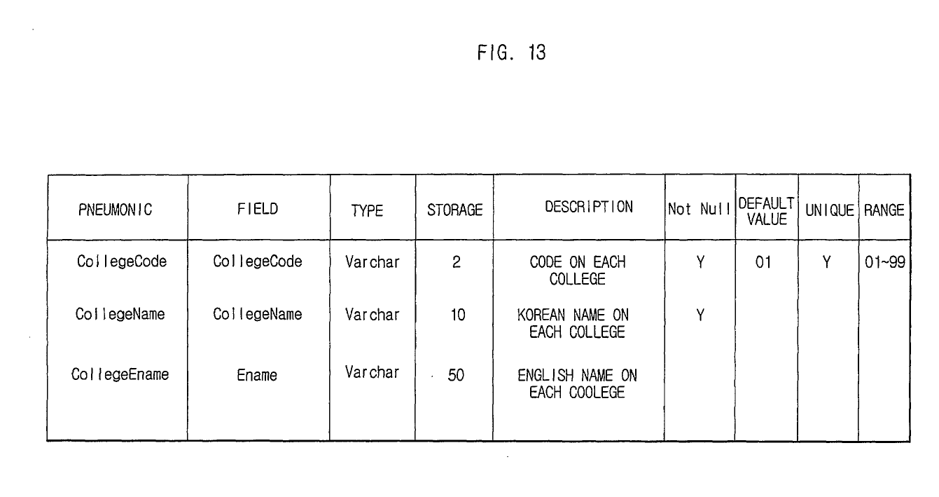

FIG. 13 illustrates a data field of the college entity depicted in FIG. 9. Referring to FIG. 13, the college entity (College) includes variables of a code for each college (CollegeCode), a name for each college (CollegeName) and an English name for each college (Ename). Every variable is of variable character format (Varchar) and requires a storage size of 2, 10 and 50 respectively.

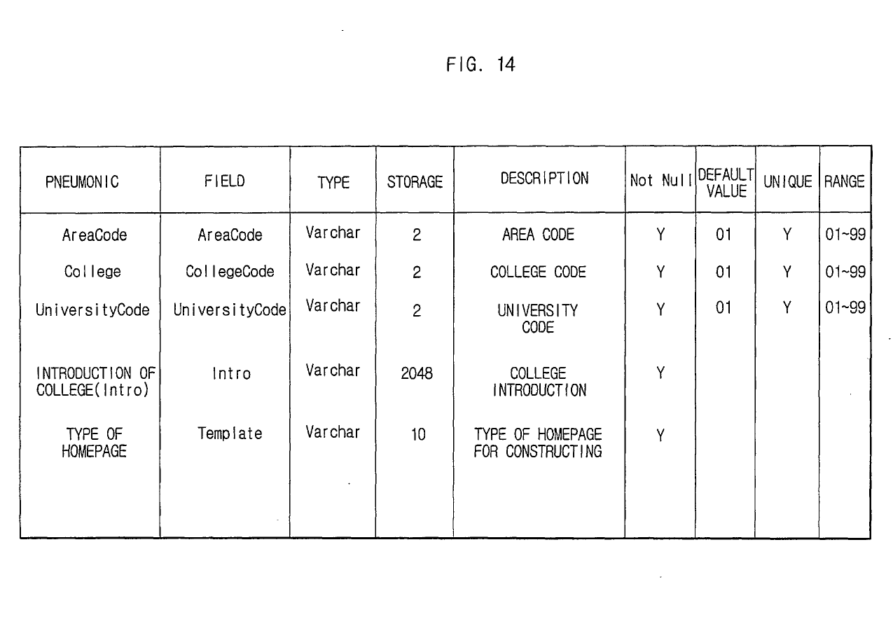

FIG. 14 illustrates a data field of the professor entity depicted in FIG. 9. Referring to FIG. 14, the professor entity (Professor) includes variables of an area code (AreaCode), college code (CollegeCode), university code (UniversityCode), professor's name (Profe), professor's home page (ProHome page) and professor's e-mail (ProEmail). Every variable is of variable character format (Varchar), and the professor's home page (ProHome page) and professor's e-mail (ProEmail) have a storage size of 255. The professor's name (Profe) has a storage size of 10.

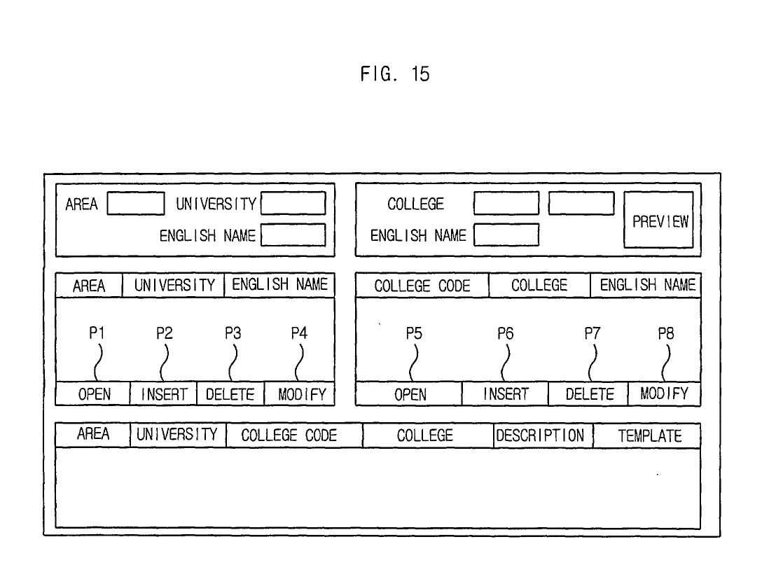

FIG. 15 illustrates a screen for managing communities in the automatic community generation system in accordance with one preferred embodiment of the present invention. The screen is described below referring to FIG. 15.

The left upper section is a screen for managing universities. A user must highlight a box of area block for inserting, deleting or modifying the information about a specified university.

The screen for managing universities fundamentally includes an area, university (university code) and English name of the university. A manager can execute specified functions by selecting university open icon P1, university insertion icon P2, university deletion icon P3 and university modification icon P4. The university open icon P1 loads information corresponding to a university from the table of universities based upon a selected area. When a manager selects the university insert icon P2 and the name of the university is input, a corresponding university code based upon area is abstracted and is stored in the database. When a manager selects the university deletion icon P3, the corresponding one or more universities are deleted from the database. It is necessary to check the request to delete repeatedly for the purpose of preventing errors. The university modification icon P4 can modify the name or English name of the selected university.

The right upper section is a screen for managing information about colleges and may include a college code, name of college, type of home page template) and English name of college. Similar to a screen for managing a university, a user may utilize the college open icon P5, the college insertion icon P6, the college deletion icon P7 and the college modification icon P8. By selecting the college open icon P5, a manager can load specified information from the college information stored in the database. The college insertion icon P6 for colleges is used for inserting new information about colleges. The college deletion icon P7 for colleges is used for deleting specified college after selecting corresponding college A manager can modify the name and English name of colleges by the college modification icon P8.

Moreover, the lower section is a screen for managing universities for each area and includes functions of college open on each university, open on each area, college delete on each university, college modify on each university and college insert on each university. Although the FIG. 15 illustrates a case where the manager modifies the information of area, university or college at a user's request, a user can be granted the managing authority among registered users as a member can personally insert, modify and delete the information of about colleges. Because of this feature, information about colleges that changes for each university every year can be modified properly.

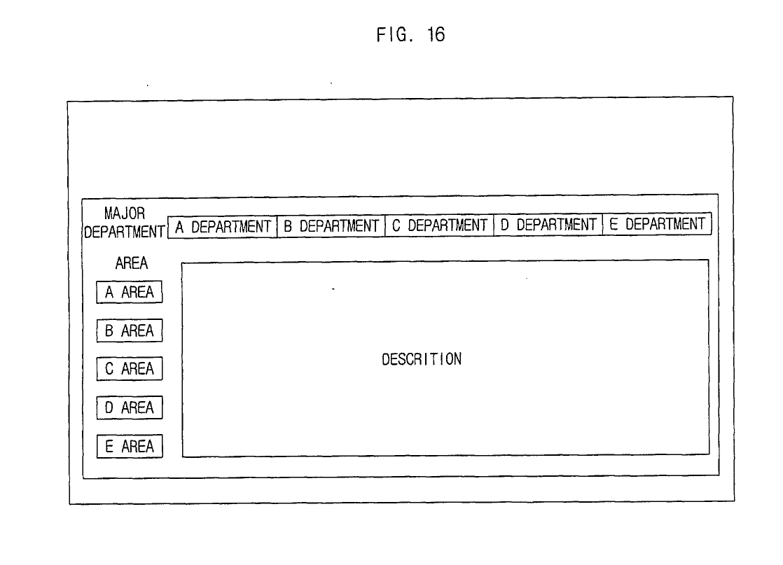

FIGS. 16 through 21 illustrate a screen showing an community generated according to the selections made by user in the automatic community generation system in accordance with one preferred embodiment of the present invention. Referring to FIG. 16, the automatic community generation system is composed of screens in accordance with structure of a database having areas that include the university from which users graduated or departments at the top level.

As depicted in the screen, areas including universities in the whole country are displayed on the left section and each department is displayed on an upper section. A user can see universities located in a specified area by selecting the area from among many areas in the left section of the screen. Similarly, the user can see universities including their specified departments by selecting a department from among many departments in an upper section of the screen. Moreover, the user can see universities having an area and a department as common factors, because selection of a specified department in the state of selecting a specified area confirms the universities including specified departments from among corresponding universities.

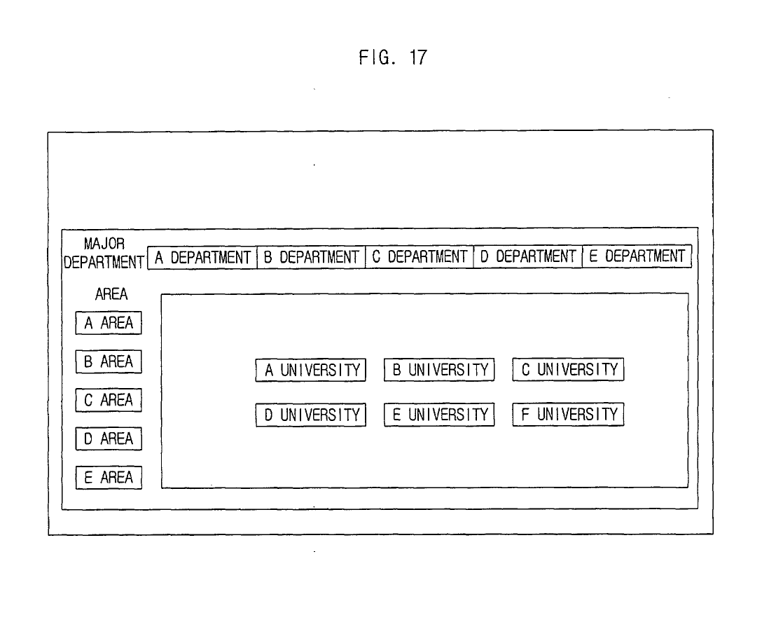

FIG. 17 illustrates a screen displayed by selecting A area after A department. When a user selects A department which the user is enrolled in, universities in the whole country having the A department are displayed. Then, when the user selects A area, universities located in A area among the universities of the whole country having the A department are displayed. Therefore, users with the same major can be active in the same community populated by individuals studying the same major regardless of university or area. Also, since the user can form more detailed communities composed of residents in the same area, it is possible to be active positively in an area community composed of people with the same major. In addition, it is possible to add a bulletin, in which members of the same community can have a conversation, with others, for the purpose of instigating an exchange of views and dialogues between the various users belonging to a community.

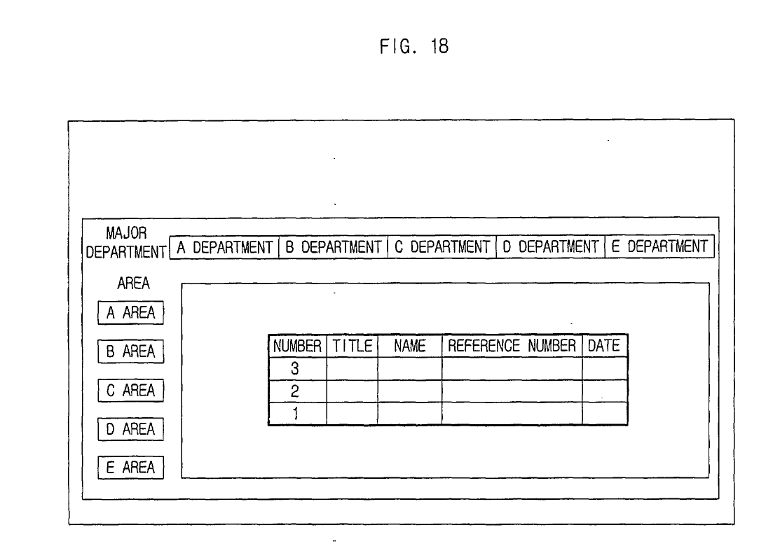

FIG. 18 illustrates a screen showing the selection a bulletin board by a user in FIG. 17. The user can see a bulletin board from major community for the A department in the A area by selecting the function of the bulletin board from entrance into the major community for A department in the A area. The function of the bulletin board is to confirm a community of the same major based on areas or departments.

A bulletin board of the A area community is activated when the user appoints a bulletin board from the state of selecting the A area. A bulletin board of the A major community is activated when the user appoints a bulletin from the state of selecting A department. Also, when a user appoints a bulletin from the state of selecting both the A area and A department, a bulletin of A area and A department communities is activated. Thus, a user can write opinions in his community and can see opinions of other members. As above, by arranging the icons of an area bulletin board and major bulletin board in the form of a matrix, the user can activate the community bulletins belonging to areas and majors.

Being constituted specific bulletins for the user's communities, for example, major department, area or university, a corresponding bulletin board is displayed in the screen by the user's request. On the other hand, constituting information of major department, area and university and reports written by users in a combined data table, it is possible to enhance the efficiency of data processing and management by displaying the reports selected from the combined data table on a screen at the user's request.

Reports written by users are displayed in the same table together with private information, major department, area and university of users utilizing the automatic community generation system of the present invention. A name, major department, area, university for the user and reports written by the user are arranged in the same column in the data table. Thus, the bulletin table can be constructed as the combined data table with the number of columns corresponding to the number of total users.

In the bulletin database constructed above, when a user requests to view a display of the bulletin board of major department, area or university on a screen, corresponding reports of major department, area or university and names of those users having written reports are selected from the combined data table and displayed as a chart on the screen.

According to another embodiment of the present invention, one record for each report may be created. A writer and information about a community including at least one report may be recorded in specified field. For example, consider the case of a user named ‘Hong Gil Dong’, who attends Seoul University with a Vocal Music major and records a report about ‘Puccini’. ‘Hong Gil Dong’ as name, ‘Seoul University’ as university community, ‘Vocal Music’ as major department community and ‘Seoul’ as area community are selected. Thus, when a plurality of communities is selected, a report called ‘Puccini’ is stored together with information about Seoul University, vocal music and Seoul.

When a user requests a bulletin board of a specific community in a bulletin database constructed as above, a dynamic bulletin is displayed by filtering data using corresponding fields. For example, it is possible to provide a bulletin service by selecting reports with ‘Seoul University’ as the university community parameter among every report.

Therefore, a user requesting to view a bulletin board can view the contents of the bulletin board as a separate bulletin board for the user's community, for example major department, area or university. The contents of a bulletin board in a screen may be composed of various combinations such as a specific major department in a specific area and a specific major department in a specific university in addition to a single community like a major department, area or university. Also, when a user requests a bulletin board with a selected combination, the bulletin board due to various combinations may be provided by selecting reports filtered according to the condition of a combination from the combined data table and by displaying sequentially the selected reports and information about the corresponding users who recorded the reports.

Moreover, it is appreciated that the bulletin board may comprise various forms such as age, sex and an occupation in addition to area and department.

A user can have more that one major. In this case, the user can subscribe to more than one community and will participate in a plurality of the communities. When the user records a report in a specific community, it is efficient to record the report automatically in other communities that include the user as a member.

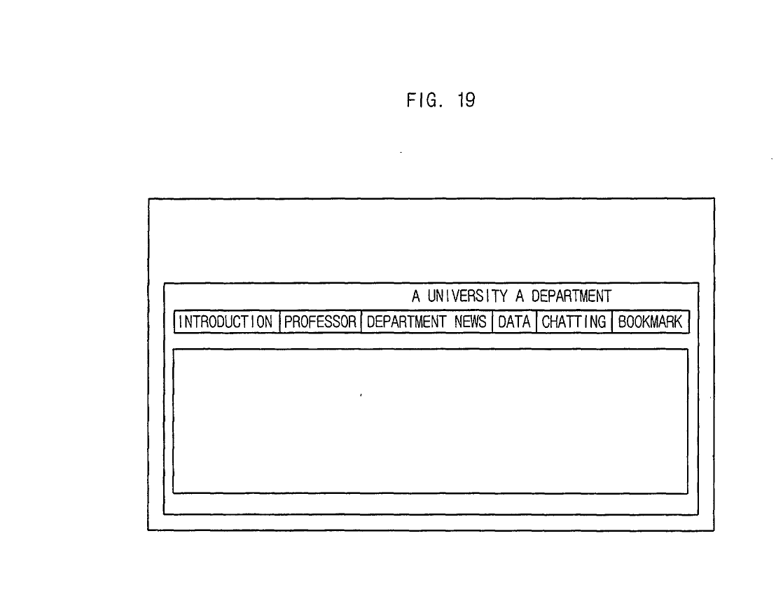

FIG. 19 illustrates a screen that demonstrates a case wherein a user selects the A university and the A department from among universities in the A area. Home pages for each department of a university may have a basic form. A manager can modify freely the format from that of the basic automatically constructed home page.

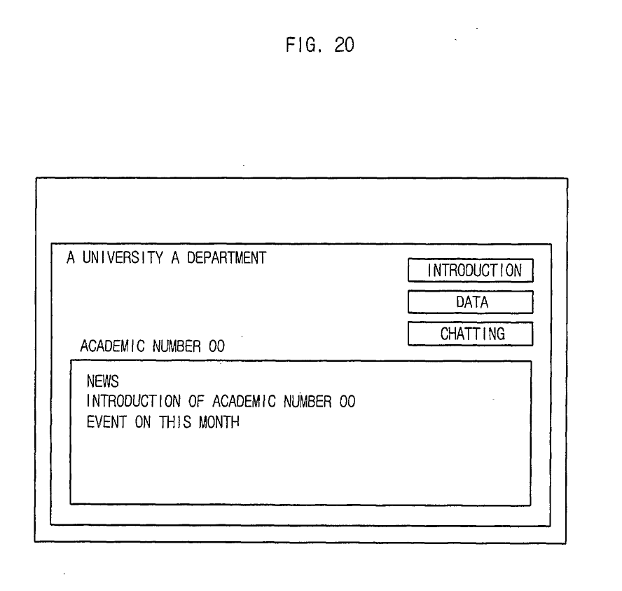

Moreover, home pages for each department may include separate home pages for each academic number. FIG. 20 illustrates a screen that demonstrates a case wherein a user selects the academic number 00 from FIG. 19. Referring to FIG. 20, there are basic home pages for each academic number similar to department home page. When a new academic number is added, a manager or a user with authority for managing can add the home page in accordance with the requests of users.

Moreover, the private home pages for users with an academic number may be generated below the screens corresponding to each academic number.

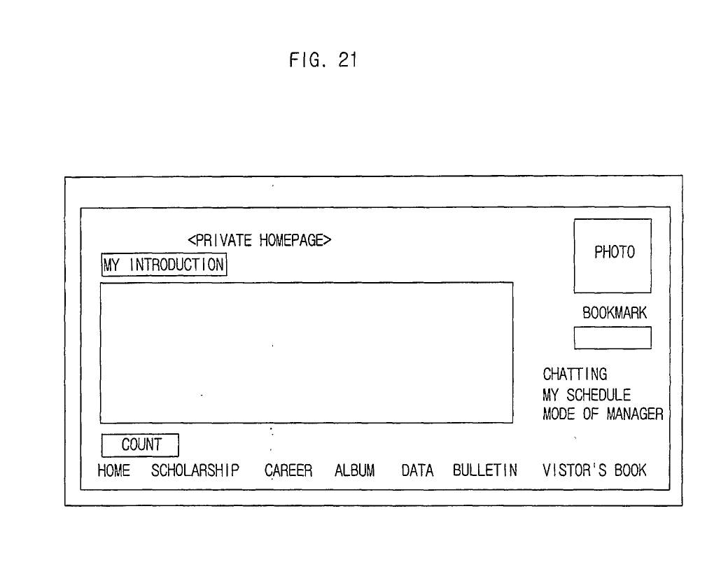

FIG. 21 illustrates a screen demonstrating a case wherein a user who has subscribed to a specific department community constructs a private home page below the screen for the academic number of the user. Referring to FIG. 21, the private basic home page is constructed automatically according to a user's information submitted during the process of registration; the user has access to that home page and can modify it freely. The user can register the private home page in a department community that has the user as a member. For example, the user enters private information such as name, scholarship, career, hobby and his introduction and registers image data including his photo or avatar. Thus, a basic home page with a specific format is provided and the user can construct a private home page to match his tastes by modifying that diversely. As depicted in FIG. 21, the private information entered by a user is arranged at a specific location according to a basic plan and image or text data may be arranged at a specific location for linking to representative web sites related to the user's taste. Also, image data related to user's major such as a department or university may be assigned as a background image and information about a community in which the user participates may be displayed also. The user's private home page is generated below a community for making the home page belong to the community as well as the member. In fact, a community wherein a user is subscribed includes that user's private home pages, which is automatically generated. The private home pages belonging to the community are created by combining the users' information and the community information. The user can easily create a plurality of private home pages stylized to reflect the characteristic of the user's community. Because the private information forming the user's private home page includes information about a community to which the user has subscribed, the user can move to the home page for that community wherein the user has subscribed via a link on the private home page.

Because it is difficult for a general user to produce a home page including images and text date, prior existing services for producing such a home page helped a user to select and arrange various templates in a basic framework of pre-constructed formats and to generate a home page by user's satisfaction for the arranged structure. However, the automatic community generation system of the present invention helps a user to generate a home page automatically by incorporating the user's own information.

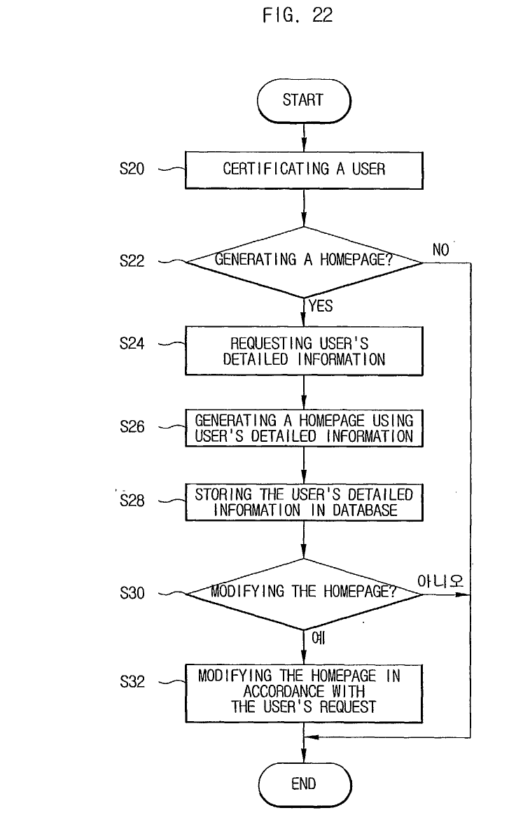

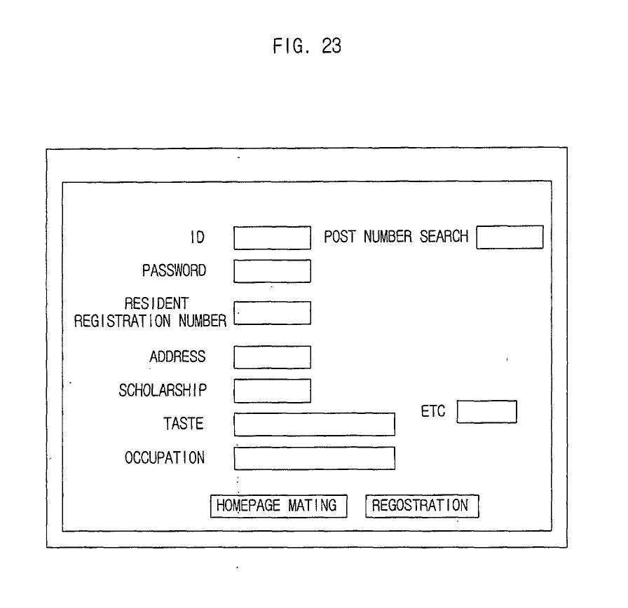

FIG. 22 is a flow chart illustrating the process of generating a home page automatically at a user's request in the automatic community generation system in accordance with one preferred embodiment of the present invention. Referring to FIG. 22, when a user requests a service of the present invention by connecting to a web server of the present invention via a network, the user may be registered as a member by entering the user's fundamental information. The user's fundamental information may include an ID, password, resident registration number, address, post number, scholarship, taste or occupation. The user's information entered in the process of registering as a member is depicted in FIG. 23.

A formation for generating home page can be made using information about the user's tastes among input information stored in a database containing user's information. For example, when a user selects a movie he or she likes as an example of tastes, site information related to that movie is linked and a background image or surrounding images may be composed of drawings related to that movie in a home page to be generated by the user. However, since more detailed information is necessary to generate a user's home page, when a user requests a generation of his home page, additive information for generating the user's home page is requested to the user (s24) after certification of the user who would be registered as a member (s20).

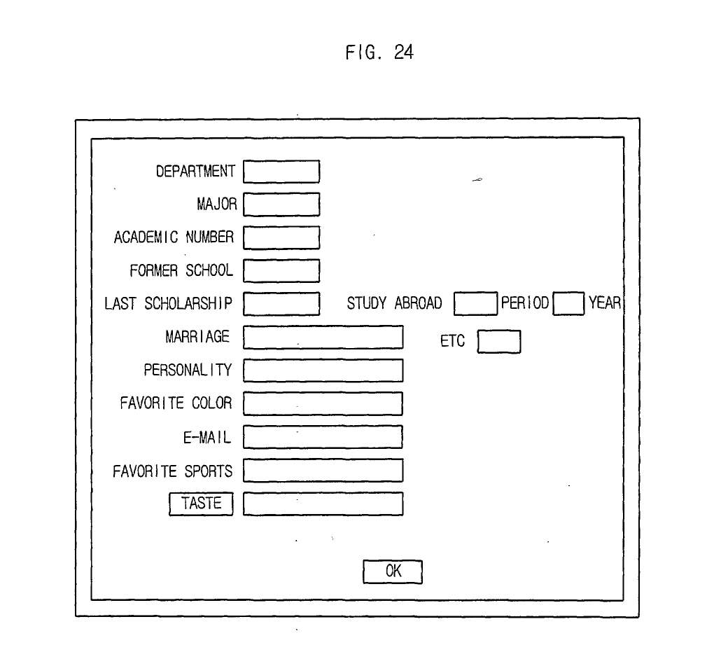

FIG. 24 illustrates a screen showing the process of additively soliciting the necessary information from a user needed to generate a home page. The additive data may include information about a department, major, academic number, former school, study abroad, marital status, tastes, favorite color, e-mail address and favorite sports of the user. For example, a user's favorite color is selected as the background color and the major is linked to sites with contents relating to that major.

During the process of generating home page automatically by separating the basic information and detailed information, it is possible to help the user to subscribe his information to create a home page in process of subscribing additive information and creating the home page automatically using the user's information. When a home page is generated by utilizing a user's information (s26), the user's information in the database will be updated by incorporating the user's subscription information (s28). Specifically, submitted information during the process of generating a home page will be used in various marketing fields afterwards and the requests of users can be replied to rapidly.

After this process, information about the user and home page information will be stored in an index database for index processing. The user information stored in the index database is related to the category information and the contents of the database and can be reflected to community generation system at the user's request.

In other words, because the home page generation system is related to the community generation system, new community information (university graduation information, major information, and academic number) from among user's private information will be used to generate a community automatically.

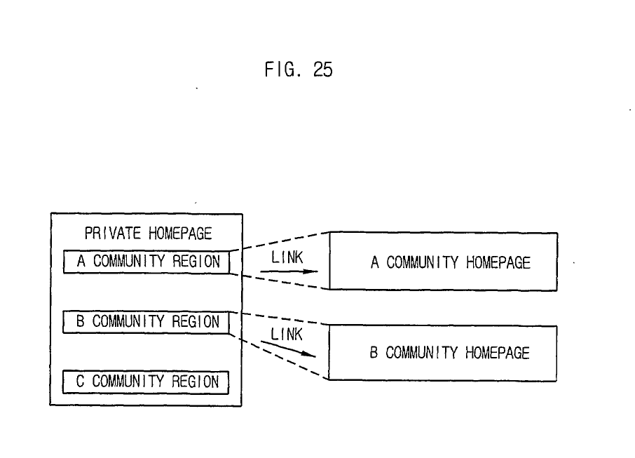

FIG. 25 is a schematic diagram illustrating the relationship between a user's private home page and a user's subscribed community home page in the automatic community generation system in accordance with one preferred embodiment of the present invention.

Referring to FIG. 25, the user's private home page includes regions linked to home pages of major departments or university communities respectively. Each region can be automatically generated from the private history information of the user in the process of generating a private home page and can be revised by the user. Specifically, the linked region may display a character with text or image data. Therefore, it may be easy to transfer to corresponding communities in accordance with a user's major department, university home page or a field for the user's interests. Since the major department, university or area can be differentiated according to the private history information provided by the user in the community generation process, this configuration can be accomplished by putting the community information related to the user into the user's private home page.

Because the private home page can include various forms about the user's private information and community information for the user's subscribed community, the user can have a private home page with various forms according to that community.

After the user's home page is generated, the user can revise the home page as desired (s32). Also, the user can revise an automatically generated home page. A user can reconstruct their own home page by revising contents such as background image, self-introduction, counter and photo, which are provided by the user in the process of registering their user's information or be selected from the user's registered information. Because the private home page is linked to the community subscriber's information in the community generated by automatic community generation system of the present invention, other users can confirm the home page or the user's home page can be easily revised at the user's request. Using these processes, the user can construct home pages such as ones for the user's department or university as well as a private home page.

Web browsers such as MS Explorer or Netscape Navigator include a bookmark tool. The bookmark tool stores the URLs of home pages displayed on a browser screen in a memory and makes it possible to move directly to a selected home page by locating the corresponding URL which has been book-marked for storage by the user.

However, automatic community generation system of the present invention does not use the bookmark tool attached to the web browser but can include a bookmark window separately. That is, when the user selects desired department or major community, the selected community information is displayed in the bookmark. If the user connects to the automatic community generation system of the present invention, the information included in the bookmark list is displayed in a bookmark window after a procedure to confirm the identity of the user is completed.

When a home page includes a plurality of frames, each of those pages will have a unique URL that can be book-marked to display only that specific frame or page of the home page site. Therefore, it is impossible to transfer to all of the pages of a home page site because each page is comprised of a unique frames.

A home page composed of a plurality of frames includes related information between each frames and the home page. Thus, when URL information is added to the bookmark, the related information between frames and home page can be stored using JavaScript and ADO object of ASP.

When storing related information between each frames and the home page, a user selects a home page composed of a plurality of frames in which each frame is arranged in a specific location, and total home page can be displayed by providing information for each frame and related information. Also, a home page can include a plurality of sub pages. When a user adds a plurality of sub page located under the same home page, to the list of a bookmark, the selected latter page is overlapped by the former page since higher pages of the latter and former page are the same. For preventing the problem, information of a new added home page is displayed with a different shape, different size, different thickness, underline or different color compared to the prior home page. Thus, a user can confirm a new list for added home page.

For example, when a user adds the A page in the bookmark list, the renewed state of the A page in the database has a No state. Then, if a manager of the A page renews the contents of the A page, the renewed state of the database turns to a Yes state according to the renewed result. Assigning colors apart for renewed state of web page Yes or No, users can easily discriminate renewed state of the web page stored in bookmark list.

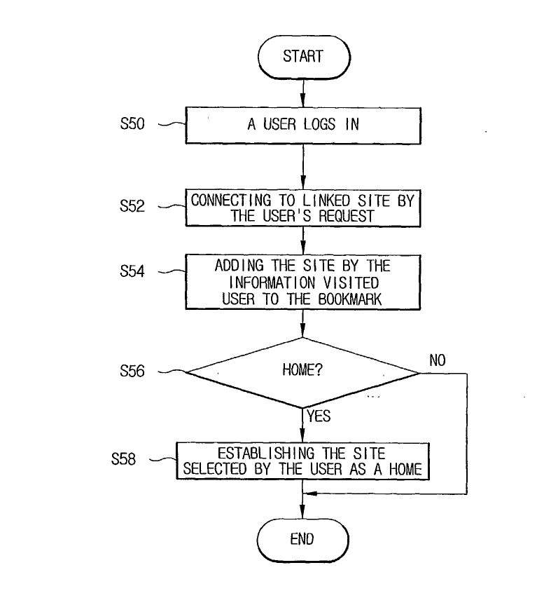

FIG. 26 is a flow chart illustrating process of using a function of bookmark by a user in the automatic community generation system in accordance with one preferred embodiment of the present invention.

Referring to FIG. 26, a user connects to web server of the present invention via network and logs in (s50). Then, the user can generate a desired community, construct own home page or can visit other web site through the web server of the present invention (s52). And, the user can store the URL of a visited web site using a bookmark tool (s54). The stored URLs of the web sites can be conveniently used to retrieve frequently visited web sites according to those deleted or added by the user. Also, the bookmark tool can include a function of Home, which displays a specified web page on the screen automatically, when a user connects to a community generation system of the present invention. Assigning a frequently visited web site from among a plurality of web sites stored in the bookmark list as home (s58), the user can automatically confirm the web site assigned as a Home by connecting to the web server of the present invention.

The automatic community generation system of the present invention was produced using Visual Basic 6.0 (Service Pack 4) as a developing tool. The OS of the developing platform was MS Windows 98 Second Edition and the database is MS SQL Server 7.0 (Service Pack 1). Also, a compiler within the Visual basic was used a compiler and execution file was produced after the selection project file. However, it can be accomplished by another programming technique using Visual C++, Java Script, or Java G++ or Dynamic Hyper Text Markup Language (DHTML) for dynamic web service.

Although it has been above described the case that community based upon a user's selected field, the major and home page are generated automatically, the automatic generation system and method can be used to generate communities based upon taste or interest as well as major and to automatically produce home pages for the communities.

Although it has been above described the university case, elementary school, middle school or high school can also be applied to the present invention. That is, locating class node instead of a department node at the top level in the case of elementary school, middle school or high school, communities based upon classes rather than school can be generated. However, since it is difficult to construct communities between various areas based upon the class as the common factor, it is preferred to locate the school node under the class node at the child level.

Also, area node is located at the top level and class node can be located under the area node. In this case, classification due to area being performed first, retrieval of school or class will be accomplished more easily. If area node is located at the top level, it is preferred to locate the school node at the child level of the class node.

In this case, users have different classes by transferring to elementary school, middle school and high school. However, users can automatically belong to each class community for each grade by recording the all contents during the registration process. Also, when a user records his or her writing to a community, the writing can be automatically recorded to other communities.

A user's various communities can be recorded on each surface of a cubic polyhedron providing visual pleasure to the experience of participating in communities.

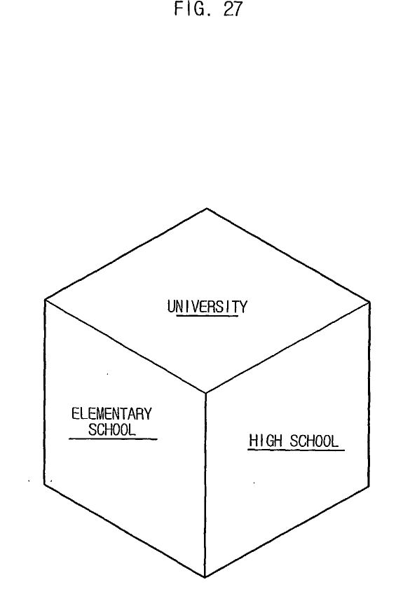

FIG. 27 illustrates a screen of displaying community titles on a three dimensional cubic polyhedron in the automatic community generation system in accordance with one preferred embodiment of the present invention.

Referring to FIG. 27, a plurality of communities, in which users are subscribed, is displayed one on each surface of a polyhedron which is capable of rotating in a specified direction. A user can assign a rotating direction to the polyhedron and can transfer to a corresponding community home page by selecting the title of the desired community from the communities on the surfaces. As previously described, in a case where the user has graduated from elementary school, middle school, high school and university, and those communities are arranged on the surfaces of the polyhedron, the user can confirm the detailed contents by selecting a community. For example, when a user selects a university community, department communities in the university are displayed on each surface of the polyhedron. Therefore, the user has a convenience and visual pleasure during the process of participating in his or her communities.

Although it has been described above the case of elementary school, middle school, high school and university, the present invention can apply equally to the communities of taste, area, business related to job, age, and sex as well as to school.

### INDUSTRIAL APPLICABILITY

As described above, based upon automatic community generation system and method of the present invention, a user can divide communities in detail and automatically generate desired communities contrary to the prior category generator that provides URL links in a manager's and developer's position.

Moreover, because the automatic community generation system and service method of the present invention provides a system and management tool for generating home pages for the individual, department, academic number or school based upon related communities for undergraduates, university graduated people, professors and experts, these users can more easily utilize the Internet.

Moreover, because the automatic community generation system and service method in the present invention incorporates the bookmark tool, which is activated in a web browser, at a web site, users can store the addresses of numerous communities on many sites and can directly connect to those sites, which are edited by the user and stored, at any time.

Although the present invention has been described in detail in terms of various embodiments for the automatic community generation system and service method of the present invention, it is not intended that the present invention be limited to these embodiments. Also, various modifications and changes within the spirit of the invention will be apparent to those skilled in the art.

1. An automatic community generation method for generating mutually distinguishable communities by constructing the communities, which are communized by a plurality of users via a network, with a hierarchical structure, said automatic community generation method comprising the steps of:
locating a major department or an area at a top level;
constructing a hierarchical data structure based upon the major department by locating category information for the major department, the area or the school at the lower level in accordance with the contents located at the top level;
generating a web page for a major community for at least one users to utilize by composing a specified form from at least one selected from a group consisting of link information related to the major department, major-related image and major-related news;
receiving user information from at least one users connected via the network, wherein, the user information includes at least one selected from a group consisting of the major department and the area; and
assigning the user as a member of at least one communities according to the user's major field from among the user information received from the user via the network.

2. The method in claim 1, wherein the user information further comprises at least one selected from a group consisting of a resident registration number, an address, a scholarship, a taste, an occupation, a major department, a marital status, a color and a study abroad.

3. The method in claim 1, wherein said step of generating a web page for a major community further comprises a step of revising the contents of the web page in accordance with the user's request.

4. The method in claim 1 further comprising a step of generating at least one user's private home page comprised of background color, inserted image, user's instructions or linked site information with pre specified forms using content information related to the user's information and the user's subscribed community.

5. The method in claim 4, wherein said step of generating at least one user's private home page further comprises a step of generating text or image with pre specified form for linking to sites related to the user's major field.

6. The method in claim 1 further comprising a step of providing a bookmark tool for immediately connecting to corresponding sites at the request of the user by storing the selected site information among a plurality of stored sites visited by the user.

7. The method in claim 6, wherein said step of providing a bookmark tool further comprises a step of establishing default starting-page for moving directly to a web page of a corresponding site by recognizing previously a default starting-page selected by the user from among sites stored by the bookmark tool in the process of connecting to the network.

8. An automatic private home page generation method comprising the steps of:
constructing a hierarchical data structure with a plurality of levels for including category information about major departments, areas and schools;
receiving user's information from the user via a network; and
generating at least one user's private home page using the user's information received from the user,
wherein the at least one user's private home page comprises a private region with private history information from among the user's information, and a major-related region including at least one selected from a group consisting of link information of web sites, images and news that are related to user's major field.

9. A method of automatic controlling bulletin boards, comprising the steps of:
constructing a hierarchical data structure with a plurality of levels for including category information related to major departments, areas and schools;
generating bulletin boards belonging to web pages of communities for major departments, areas or schools to display writings recorded by members of each community at the user's request;
assigning the users to corresponding communities according to user's information provided by users via a network; and
registering a writing being recorded by a user to all bulletin boards of the communities to which the user has been subscribed or to bulletin boards selected by the user for external reading when the user records a writings to specific bulletin board.

10. An automatic user's home page generation method comprising the steps of:
receiving user's information from the user via a network;
receiving at least one piece of information to be used for the purpose of selecting a community for the user;
storing contents for displaying on a home page for the community or locating the existing contents among the user's information in a database; and
generating at least one user's home page for at least one community using information from the user or communities.

11. A method of displaying bulletin boards, comprising the steps of:
receiving information from users and at least one community which includes the users via a network;
receiving writings recorded by the users; and
storing the writings in a database for connection to at least one other writing belonging to at least one community related to users,
wherein, the writings are displayed on bulletin boards of related communities for optional viewing by community members.

12. The method in claim 11, wherein said step of storing the writings in a database comprises the steps of:
selecting information for at least one community including the writings recorded by the users from the user's information, wherein, the database having stored the writings includes at least one community field; and
storing the selected information for the communities as well as the writings in corresponding fields.

13. A method of accomplishing a function of bookmark, comprising the steps of:
receiving information from users and at least one community which includes the users via a network;
storing home page information for the communities selected by the users, at least one frame information comprising the home page and relationship information for each frame in a database;
providing corresponding home page information to the users at the user's request;
adding address information for selected home pages which correspond to each user's private home page information from among a plurality of home page when a user makes a request to register;
displaying the added home page information in a side screen of the user's private home page at the user's request to register; and
converting the screen to corresponding home page from among the added home page information displayed in a side screen at the user's selection.

14. An automatic community generation system for automatically generating communities for a user's major field via a network, said automatic community generation system comprising:
a memory system including a database for the user's information and community information;
at least one processor connected to said memory system;
an input device for entering signals provided via the network to said processor; and
an output device for generating output signal from said processors,
wherein, the database comprises an area entity including area code and information related to corresponding area, a university entity, which includes the area code, university code and information related to corresponding universities, connected to said area entity by the area code, a home page entity, which includes the area code, university code, department (college) code and information related to the home page of the department (college), connecting to said university entity by the area code and university code, a department (college) entity, which includes the department (college) code and information related to the department (college), connecting to said home page entity by the department (college) code, and a professor entity, which includes the area code, university code, department (college) code and information related to the professor, connected to said university entity by the area code and university and connected to said department (college) entity by the department (college) code.

15. An automatic community generation system, comprising:
a memory system having a database including category information that composed of information for major department located at a top level and for corresponding area or university located at the lower level together with user's information;
a transmitter for transmitting the category information based upon the major department at the user's request; and
a community generator for generating the major community for the field requested by the user from among the category information.

16. The system in claim 15, said database comprising:
an area entity including area code and information related to corresponding area;
a university entity, which includes the area code, university code and information related to corresponding universities, connected to said area entity by the area code;
a home page entity, which includes the area code, university code, department (college) code and information related to the home page of the department (college), connecting to said university entity by the area code and university code;
a department (college) entity, which includes the department (college) code and information related to the department (college), connected to said home page entity by the department (college) code; and
a professor entity, which includes the area code, university code, department (college) code and information related to the professor, connected to said university entity by the area code and university and connected to said department (college) entity by the department (college) code.

17. The system in claim 15 further comprising a home page generator for generating private home pages with pre specified forms utilizing a user's private profile from among the user's information.

18. The system in claim 15 further comprising a provider of bookmark tool for connecting immediately to a registered home page at a user's request and displaying the registered home page information in a side of screen of user's private home page after registering the address information of the home page selected from among those home pages frequently visited by the user.

19. An automatic community generation system, comprising:
a memory system having a hierarchical data structure including category information composed of information for area located at a top level and for major department or university located at the lower level together with the user's information;
a transmitter for transmitting the category information based upon the major department at the user's request; and
a community generator for generating the major community for the field requested by the user from among the category information.

20. The system in claim 19, said hierarchical data comprising:
an area entity including area code and information related to corresponding area;
a university entity, which includes the area code, university code and information related to corresponding universities, connected to said area entity by the area code;
a home page entity, which includes the area code, university code, department (college) code and information related to the home page of the department (college), connected to said university entity by the area code and university code;
a department (college) entity, which includes the department (college) code and information related to the department (college), connected to said home page entity by the department (college) code; and
a professor entity, which includes the area code, university code, department (college) code and information related to the professor, connected to said university entity by the area code and university and connected to said department (college) entity by the department (college) code.

21. An automatic community generation system, comprising:
a memory system having a hierarchical data structure with a plurality of levels including category information for major department, area and university;
a transmitter for transmitting the category information based upon the major department at the user's request; and
a community generator for generating the major community of the field requested by the user from among the category information.

22. The system in claim 21, wherein the category information comprises information for major department or area located at a top level and for corresponding area, major department or university located at the lower level.

23. A computer-readable medium having stored thereon computer-executable instructions and realized in concrete by a program of instructions, which could be executed by a digital processing unit, for generating a community held in common by a plurality of users automatically via network, said method of generating community automatically comprising the steps of:
locating a major department or area at a top level;
constructing a hierarchical data structure based upon the major department by locating category information for the major department, area or school at the lower level according to the contents located at the top level;
generating a web page for a major community for use by at least one user by composing a specified form from at least one selected from a group consisting of link information related to the major department, major-related image and major-related news;
receiving user information from at least one users connected via the network, wherein, the user information includes at least one selected from a group consisting of major department and area; and
assigning the user as a member of at least one community according to the user's major field from among the user information received from the user via the network.

24. A computer-readable medium having stored thereon computer-executable instructions and realized in concrete by a program of instructions, which could be executable by a digital processing unit, for generating a user's private home page automatically via a network, said method of generating user's private home pages automatically comprising the steps of:
constructing a hierarchical data structure with a plurality of levels for including category information about major departments, areas and schools;
receiving user's information from the user via the network; and
generating at least one user's private home pages using the received user's information,
wherein the at least one user's private home page comprises a private region with private history information from among user's information, and a major-related region including at least one selected from a group consisting of link information of web sites, images and news related to a user's major field.

25. A computer-readable medium having stored thereon computer-executable instructions and realized in concrete by a program of instructions, which could be executable by a digital processing unit, for displaying a user's bulletin board dynamically via a network, said method of displaying user's bulletin board dynamically comprising the steps of:
receiving information from users and at least one community which includes the users via network;
receiving writings recorded by the users; and
storing the writings in a database for connection to at least one other writing belonging to at least one community related to users,
wherein, the writings are displayed on bulletin boards of related communities for optional viewing by community members.

26. A computer-readable medium having stored thereon computer-executable instructions and realized in concrete by a program of instructions, which could be executable by a digital processing unit, for accomplishing a bookmark tool via a network, said method of accomplishing the bookmark tool comprising the steps of:
receiving information from users and at least one community which includes the users via the network;
storing home page information for the communities selected by the users, at least one frame information comprising the home page and relationship information for each frame in a database;
providing corresponding home page information to the users at the user's request;
adding address information of the selected home page to a user's private home page information taken from among a plurality of home page during the procedure followed when a user makes a request to register;
displaying the added home page information in a side screen on the user's private home page when a user makes a request to register; and
converting the screen to corresponding home page from among the added home page information displayed on a side screen when selected by a user.
